(19) United States
(12) Patent Application Publication
(10) Pub. No.: US 2005/0190262 A1
(43) Pub. Date: Sep. 1, 2005

(54) Vehicle video recording and processing system

(76) Inventor: Majed M. Hamdan, North Olmsted, OH (US)

Correspondence Address: Michael J. D'Aurelio;D'Aurelio & Mathews, LLC, 96 Church Street, Chagrin Falls, OH, 44022, US

(21) Appl. No.: 10/872,061

(22) Filed: Jun. 18, 2004

Related U.S. Application Data
(63) Continuation-in-part of application No. 10/787,786, filed on Feb. 26, 2004.

(51) Int. Cl. H04N 7/18

(52) U.S. Cl. 348/148; 348/143

(57) ABSTRACT

Disclosed are various systems and methods for processing and displaying video in a vehicle. In one embodiment, a vehicle video system is provided that comprises cameras and monitors mounted in a vehicle. Each of the cameras generates a video image, the cameras including a plurality of visible light cameras and a plurality of night vision cameras. The vehicle video system also includes a video processing unit that is configured to select at least two subsets of the cameras and to generate an output video image that incorporates at least one of the video images generated by at least one of the cameras in a first one of the subsets. The vehicle video system also includes a digital video recording processor included in the video processing unit that cyclically records a predefined time period of the output video image.

### CROSS REFERENCE TO RELATED CASES

This patent application claims priority to and is a Continuation-in-Part of U.S. patent application Ser. No. 10/787,786 filed on Feb. 26, 2004 entitled “Vehicle Video Processing System”, which is incorporated herein by reference in its entirety.

### BACKGROUND

The use of vision systems in commercial vehicles provides for enhanced viewing around a commercial vehicle. In some situations, various views are limited to a select few cameras on a commercial vehicle that do not provide complete awareness of the surrounding environment to an operator of the commercial vehicle. Consequently, the operator may be hampered during driving or other activity with respect to the commercial vehicle.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 depicts a block diagram of a vehicle employing a vehicle video system according to an embodiment of the present invention;

FIG. 2 depicts a schematic block diagram of a video processing unit employed as part of the vehicle video system of FIG. 1 according to an embodiment of the present invention;

FIG. 3 depicts a block diagram of a video image selector employed in the vehicle video system of FIG. 1 according to an embodiment of the present invention;

FIG. 4 depicts a schematic block diagram of a control processor employed in the video processing unit of FIG. 2 according to an embodiment of the present invention;

FIGS. 5A-5D depict flow charts that illustrate one example of a control system executed by the control processor of FIG. 4 according to an embodiment of the present invention;

FIG. 6 depicts a schematic block diagram of a video processing unit employed as part of the vehicle video system of FIG. 1 according to another embodiment of the present invention;

FIG. 7 depicts a block diagram of a video image selector employed in the vehicle video system of FIG. 1 according to an embodiment of the present invention;

FIG. 8 depicts a schematic block diagram of a control processor employed in the video processing unit of FIG. 2 according to an embodiment of the present invention; and

FIG. 9 depicts a flow chart that illustrates one example of a portion of a control system executed by the control processor of FIG. 6 according to an embodiment of the present invention.

### DETAILED DESCRIPTION

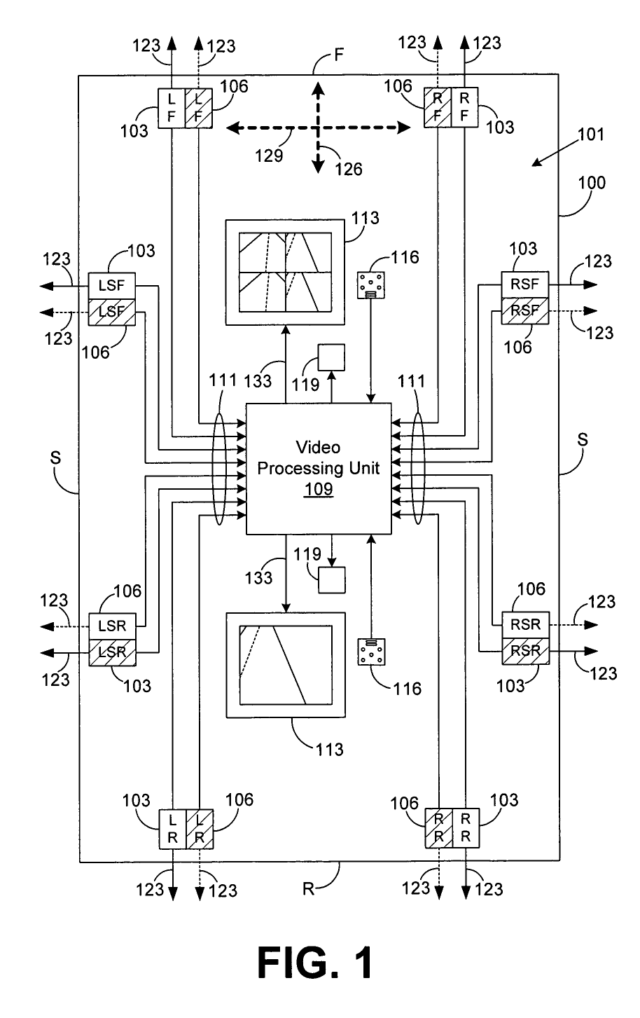

Referring to FIG. 1, shown is a block diagram of a vehicle 100 according to an embodiment of the present invention. The vehicle 100 may be, for example, a commercial vehicle such as a truck, tractor-trailer, or other commercial vehicle. The commercial vehicle may also be a general purpose vehicle that is used, for example, by law enforcement or other agencies to obtain visual information regarding the environment surrounding the commercial vehicle itself. Generally, the vehicle includes a front F, rear R, and sides S.

To this end, the vehicle 100 includes a vehicle video system 101 having a plurality of cameras mounted on or in the vehicle 100. Specifically, the cameras include a number of visible light cameras 103 and a number of night vision cameras 106. Alternatively, a single camera may be employed in the place of one of the visible light cameras 103 and one the night vision camera 106 that includes both visible light and night vision capability. In addition, the vehicle video system 101 includes a video processing unit 109. Each of the cameras 103, 106 are electrically coupled to the video processing unit 109 and each of the cameras 103, 106 generates a video image 111 that is applied to the video processing unit 109. In this respect, the video processing unit 109 includes a number of video inputs to facilitate the electrical coupling with each of the cameras 103, 106. The video system within the vehicle 100 also includes a plurality of monitors 113. Each of the monitors 113 is also electrically coupled to the video processing unit 109 through video output ports on the video processing unit 109.

The vehicle video system 101 further includes video image selectors 116 that may be hand-held devices or may be mounted in the commercial vehicle 100 in an appropriate manner. Each of the video image selectors 116 enable an operator to control the video displayed on a respective one of the monitors 113. Specifically, each of the video image selectors 116 is associated with a respective one of the monitors 113 and controls the video displayed thereon as will be described. Each of the video image selectors 116 may be coupled to the video processing unit 109 through an appropriate vehicle data bus or by direct electrical connection as will be described.

In addition, the video system in the vehicle 100 includes audible alarms 119 that are coupled to the video processing unit 109. In this respect, the audible alarms 119 are sounded upon detection of predefined conditions relative to the video system within the vehicle 100 as will be described. Alternatively, the video processing unit 109 may generate visual alarms on the monitors 113 as will be described. Also, both audible alarms 119 and visual alarms may be employed in combination, etc.

The cameras 103, 106 are mounted within the vehicle 100, for example, so that a field of view 123 of each of the cameras 103, 106 is oriented in either a substantially longitudinal direction 126 or a substantially lateral direction 129 with respect to the vehicle 100. In this respect, the longitudinal direction 126 is generally aligned with the direction of travel of the vehicle 100 when it moves in a forward or reverse direction. The lateral direction 129 is substantially orthogonal to the longitudinal direction 126.

Some of the cameras 103, 106 are oriented so as to have a field of view 123 oriented in the substantially longitudinal direction 126 with respect to the vehicle 100, whereas other cameras 103, 106 are oriented so as to have a field of view 123 oriented in the substantially lateral direction 129. In this respect, cameras 103, 106 are provided that can generate video images 111 that show views of the environment all around the entire vehicle 100. In one embodiment, the angle of the fields of view 123 of the cameras 103, 106 may differ depending upon their location and orientation relative to the vehicle 100. For example, the cameras 103, 106 that are oriented so that their field of view 123 is forward facing in the longitudinal direction may have an angle associated with their field of view 123 that is less than the angle of the field of view 123 of the rearward facing cameras 103, 106 in the longitudinal direction. In one specific embodiment, the angle of the field of view 123 of such forward facing cameras 103, 106 is 12 degrees, and the angle of the field of view 123 of the rearward facing cameras 103, 106 is approximately 153 degrees, although the angles of the fields of views 123 of the forward and reverse facing cameras 103, 106 may differ from these values depending upon the desired viewing capabilities of the vehicle video system 101.

The video processing unit 109 is configured to select a number of subsets of the cameras 103, 106 from which output video images 133 may be generated. In this respect, the video processing unit 109 generates at least two output video images 133 that are applied to corresponding ones of the monitors 113. In one embodiment, a first output video image 133 incorporates one or more video images 111 generated by a corresponding one or more of the cameras 103, 106 included in a first one of the subsets of the cameras 103, 106. At the same time, a second output video image 133 incorporates one or more video images 111 generated by a corresponding one or more of the cameras 103, 106 included in a second one of the subsets of the cameras 103, 106.

According to an embodiment of the present invention, the video processing unit 109 independently displays the first output video image 133 on a first one of the monitors 113 and the second output video image 133 on a second one of the monitors 113. In this respect, the output video images 133 displayed on either one of the monitors 113 does not affect or dictate the output video image 133 displayed on the other one of the monitors 113. In addition, there may be more than two of the monitors 113 (not shown) and more than two output video images 133 (not shown) generated by the video processing unit 109, etc.

Each of the output video images 133 that are generated by the video processing unit 109 may incorporate one or more video images 111 generated by a corresponding one or more of the cameras 103, 106 in a respective one of the subsets of the cameras 103, 106. In this respect, a user may manipulate one of the video image selectors 116 that are configured to select which of the video images 111 from which one of the cameras 103, 106 within a subset are to be incorporated into a respective output video image 133 to be applied to a respective one of the monitors 113. The output video images 133 may incorporate a single one of the video images 111 or multiple ones of the video images 111 generated by cameras within a respective one of the subsets.

The cameras 103, 106 selected to be in one of the subsets from which the output video images 133 are generated may be selected according to various characteristics. For example, a given subset of cameras 103, 106 may include only visible light cameras 103 or only night vision cameras 106. In this respect, an operator can thus dictate that the output video images 133 incorporate video images 111 generated entirely by visible light cameras 103 or night vision cameras 106, depending upon the nature of the environment surrounding the vehicle 100.

Alternatively, a given selected subset of cameras 103, 106 may include only cameras 103, 106 that have a field of view that is oriented along the longitudinal direction 126 or oriented along the lateral direction 129. In this respect, an operator can thus dictate that the output video images 133 display views directed solely to the forward and rear of the vehicle 100 or views directed to the environment at the side of the vehicle 100.

The video processing unit 109 is also configured to detect a motion within a field of view 123 of each of the cameras 103, 106 that are included within any of the subsets of the cameras 103, 106. When motion is detected within the field of view of a respective one of the cameras 103, 106, the video processing unit 109 may generate an alarm that alerts operators within the vehicle 100 of such motion. In this respect, the alarm may comprise, for example, the incorporation of a border, alarm text, or other imagery within the output video images 133 displayed on the monitors 113. The border, alarm text, or other imagery may be generated within the video images 111 incorporated within the output video image 133, for example, if the motion is detected in such video images 111.

Alternatively, the alarms may comprise the audible alarms 119 or both a video image alarm and an audio alarm 119. In some situations, the output video image 133 viewed on a particular monitor 133 may not incorporate a video image 111 generated by one of the cameras 103, 106 that is included within a particular subset of the cameras 103, 106. The video processing unit 109 may also detect motion in the video image 111 that is excluded from the output video image 133. In such case, an alarm may be generated that informs an operator that motion was detected in a video image 111 generated by a camera 103, 106 that is not currently viewed on one of the monitors 113. In this respect, operators are advantageously made aware of motion that they cannot see in any of the video images 111 incorporated into the output video images 133 viewed on the respective monitors 113. Such an alarm may differ in appearance or may sound different compared to an alarm due to motion detected in a video image 111 that is incorporated into an output video image 133 that is displayed on a monitor 113.

Thus, according to one embodiment of the present invention, different alarms are sounded for motion detected within a video image 111 that is incorporated within an output video image 133 displayed on a monitor 113 and for motion detected within a video image 111 that is excluded from an output video image 133 displayed on a respective monitor 113. As additional embodiments, differing alarms can be generated depending upon where the motion is detected relative to the vehicle 100. Specifically, differing alarms may be generated depending upon which of the video images 111 from the cameras 103, 106 the motion is detected, thereby providing instantaneous information to an operator as to where motion is detected relative to the vehicle 100 itself.

In still another embodiment, the video processing unit 109 may operate on a respective video image 111 from one of the cameras 103, 106 to generate a mirror image therefrom for purposes of showing images from rear facing cameras 103, 106 in a manner that does not confuse an operator as to the orientation of the fields of view 123 of respective ones of the cameras 103, 106.

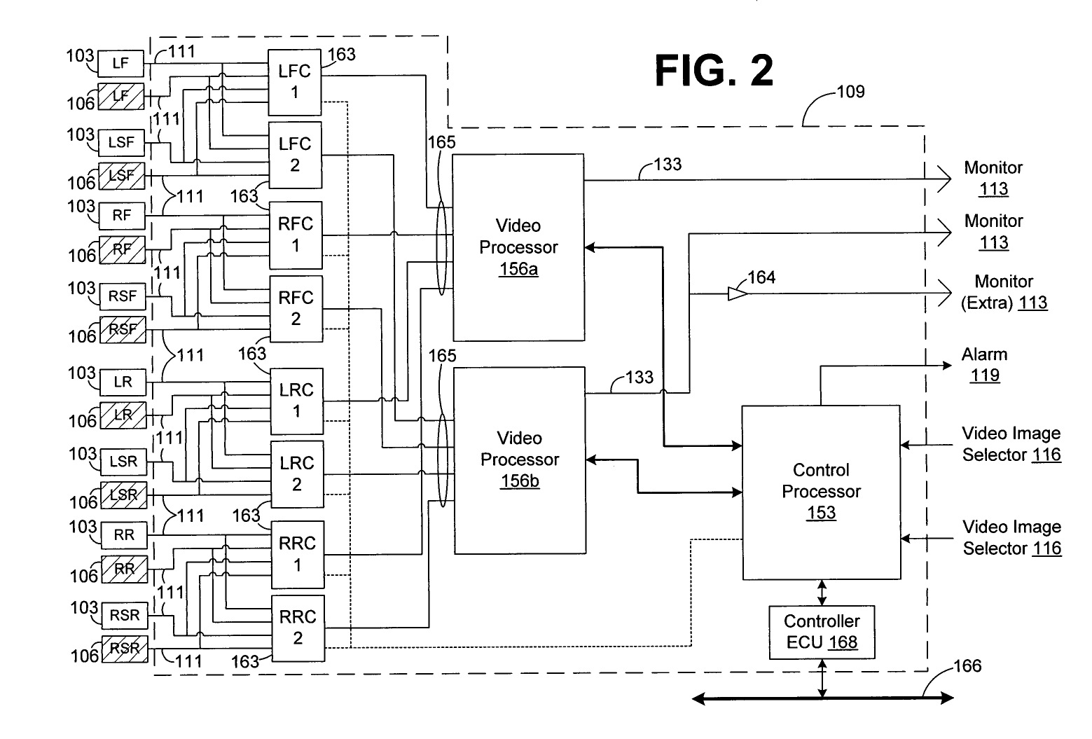

With respect to FIG. 2, shown is a schematic of the video processing unit 109 according to an embodiment of the present invention. The video processing unit 109 includes a control processor 153, and at least two video processors 156a and 156b. The control processor 153 is electrically coupled to each of the video processors 156a and 156b to facilitate data communications therebetween. The control processor 153 may be, for example, a Motorola MC9S12DG128 microprocessor manufactured by Motorola Semiconductor of Austin, Tex. Each of the video processors 156a/156b may be, for example, an Averlogic AL700C video processor manufactured by Averlogic Technologies, Inc., of San Jose, Calif.

The video processing unit 109 further comprises a number of video encoders 163. The output of each of the video encoders 163 is applied to a number of multiplexed inputs of one of the video processors 156a/156b. Each of the video encoders 163 performs the function of converting the video images 111 generated by the cameras 103, 106 in the form of an analog signal into a digital video signal that is recognizable by the video processors 156a/156b. Each of the video encoders 163 is associated with a respective corner of the vehicle 100 (FIG. 1). In this respect, two of the video encoders 163 are associated with the left front corner (LFC), two of the video encoders 163 are associated with the right front corner (RFC), two of the video encoders are associated with the left rear corner (LRC), and the remaining two video encoders 163 are associated with the right rear corner (RRC) of the vehicle 100. Each of the video encoders 163 may be, for example, a Phillips SAA7113H encoder manufactured by Phillips Semiconductors of Eindhoven, Netherlands.

Each of the left front corner (LFC) video encoders 163 receives inputs from the left front (LF) cameras 103, 106 and the left side front (LSF) cameras 103, 106. Also, the right front corner (RFC) video encoders 163 receive inputs from the right front (RF) cameras 103, 106, and the right side front (RSF) cameras 103, 106. The left rear corner (LRC) video encoders 163 receive inputs from the left rear (LR) cameras 103, 106 and the left side rear (LSR) cameras 103, 106. Finally, the right rear corner (RRC) video encoders 163 receive inputs from the right rear (RR) cameras 103, 106 and the right side rear (RSR) cameras 103, 106.

The respective video inputs 111 into each of the video encoders 163 are multiplexed through a single output that is applied to one of the video processors 156a, 156b. For example, a first one of the left front corner (LFC) video encoders 163 applies its output to the video processor 156a and the remaining left front corner (LFC) video encoder 163 applies its output to the video processor 156b. Similarly, the outputs of the various pairs of video encoders 163 are applied to one of the video processor 156a and 156b. Ultimately, the encoders 163 facilitate the selection of the subset 165 of video images 111 generated by respective ones of the cameras 103, 106 that are applied to the video processors 156a/156b to be incorporated into the video output signals 133 as described above. In this respect, the control processor 153 is electrically coupled to each of the encoders 163 and executes a control system that controls the operation of each of the encoders 163 in selecting various ones of the video images 111 that are applied to the inputs of the video processors 156a, thereby selecting the subset of the cameras 103, 106 that generate video images 111 that are incorporated into a respective one of the output video images 133.

Given that the video encoders 163 are grouped in pairs that receive identical inputs as from four cameras as shown, and given that each video encoder 163 within each pair provides its output to a separate one of the video processors 156a and 156b, then the multiplexed inputs of the video processors 156a/156b can receive the same video images 111 generated by the various cameras 103, 106. In this respect, video images 111 generated by any one of the cameras 103, 106 may be applied to each one of the video processors 156a, 156b.

The video processors 156a/156b each generate the video output images 133 (FIG. 1) that are applied to the monitors 113. In this respect, each video processor 156a, 156b is associated with a respective one of the monitors 113. Alternatively, the output of a single one of the video processors 156a, 156b may be applied to multiple monitors 113 simultaneously using appropriate buffer circuitry 164 to prevent overloading various outputs, etc.

In generating the various output video images 133, each of the video processors 156a/156b can perform various processing operations relative to the video images 111 received from respective ones of the cameras 103, 106. For example, each of the video processors 156a/156b can incorporate any number of the video images 111 received from the selected cameras 103, 106 into a single output video image 133 that is applied to a respective one of the monitors 113. Also, each of the video processors 156a/156b include motion detection capability with respect to each of the video images 111 received from one of the selected cameras 103, 106. Such motion detection may be performed, for example, by performing screen to screen comparisons to detect changes in the video images 111 over time, etc. Once motion is detected in a respective video image 111, the respective video processor 156a/156b may set a register to a predefined value that is then supplied to the control processor 153. The control processor 153 is thus programmed, for example, to perform various tasks in reaction to the value in the register such as executing an alarm or taking some other action, etc.

Each of the video processors 156a/156b may perform a mirror image operation with respect to any one of the video images 111 received from one of the cameras 103, 106, thereby generating a mirror video image therefrom. Such a mirror image may be including in one of the output video images 133 where appropriate, for example, for viewing reverse directions on a respective monitor 113. Also, each of the video processors 156a/156b may perform a digital zoom function and a pan function with respect to one of the video images 111. For example, the digital zoom function may involve performing a 2× digital zoom or a digital zoom of greater magnification. The pan function involves scrolling up, down, left, and right to make unseen portions of a zoomed video image 111 appear on a respective monitor 113. The zoom and pan functions are discussed in greater detail in the following text.

In addition, each of the video processors 156a, 156b includes memory in which is stored various templates of images, such as icons, symbols, or other images, or text that may be overlaid onto a respective output video image 133 displayed on a monitor 113 as directed by the control processor 153, etc. Specific examples of images such as text that may be overlaid onto a respective output video image 133 include, for example, information indicating from which camera a particular video image 111 depicted within the output video image 133 has been generated.

In addition, the control processor 153 includes inputs that facilitate an electrical coupling of the video image selectors 116 directly to the control processor 153. Alternatively, the control processor 153 may be coupled to a vehicle data bus 166 through a controller electronic communications unit (ECU) 168. As an additional alternative, the control processor 153 may be coupled directly to the vehicle data bus 166, where the control processor 153 incorporates the functionality of the electronics communications unit (ECU) 168. In this respect, each of the video image selectors 116 may also coupled to the data bus 166 associated with the vehicle 100 and communicate to the control processor 153 there through. In this respect, the vehicle data bus 166 may operate according to any one of a number of a number of vehicle data communication specifications such as, for example, SAE J1587, “Electronic Data Interchange Between Microcomputer Systems in Heavy-Duty Vehicle Applications” (February 2002); SAE J1939/71, “Vehicle Application Layer” (December 2003); or SAE J2497, “Power Line Carrier Communications for Commercial Vehicles” (October 2002) as promulgated by the Society of Automotive Engineers, the entire text of each of these standards being incorporated herein by reference.

Given that the control processor 153 may be coupled directly to a vehicle data bus 166, it can receive data information that describes general operational aspects of the vehicle 100 that is transmitted on the vehicle data bus 166. The control processor 153 may then be programmed to direct the video processors 156a/156b to overlay such information onto one of the output video images 133. Such information may include text or other images that describes operational aspects of the vehicle 100 such as whether the vehicle 100 is moving, gear settings, engine diagnostic information, other vehicle diagnostic information, and other information, etc.

In addition, the control processor 153 includes an alarm output that may be used to drive the audible alarms 119. Specifically, as an alternative, there may be multiple audible alarms 119 coupled to the control processor 153 beyond the two shown that are used to indicate various alarm conditions that may be detected with the video processing unit 109. Also, a single alarm may be driven in different ways to indicate different alarm conditions. For example, the audible alarms 119 may include a speaker that can be driven to generate multiple different alarm sounds, etc.

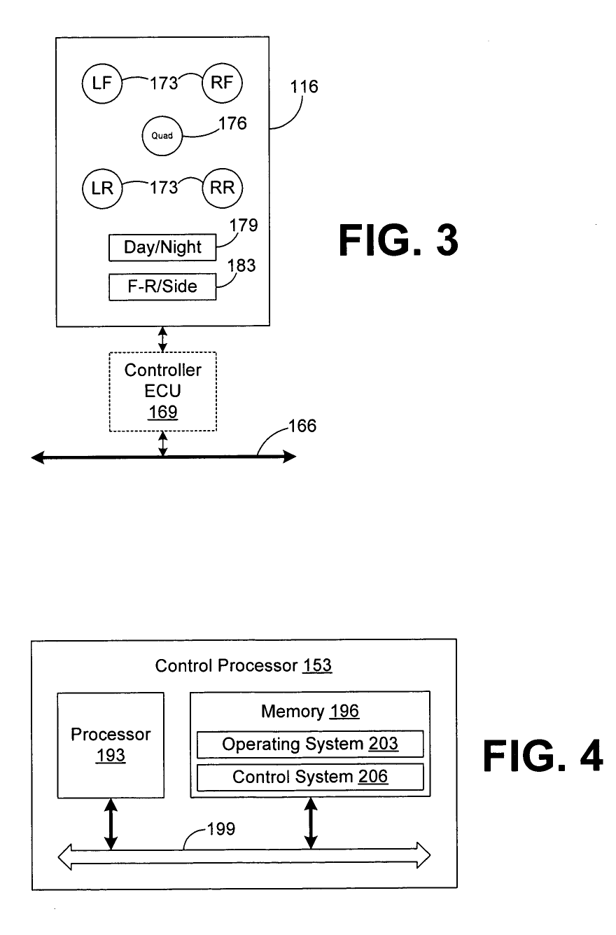

Turning then to FIG. 3, shown is a video image selector 116 according to an embodiment of the present invention. The video image selector 116 includes a number of buttons that perform various functions as will be described. The video image selector 116 is coupled to the video processing unit 109 by either a direct electrical connection or through the vehicle data bus 166 as described above. Assuming that the video image selector 116 is coupled to the video processing unit 109 through the vehicle data bus 166, then a controller electronic communications unit (ECU) 169 is employed to couple the video image selector 116 to the data bus 166. In this respect, the controller ECU 169 receives signals from the video image selector 116 when various ones of the buttons thereon are depressed, and the controller ECU 169 generates appropriate messages on the vehicle data bus 166 according to the predefined protocol associated with the vehicle data bus as described above. Alternatively, where the video image selector 116 is directly connected to the video processing unit 109, then electrical signals may be transmitted to the video processing unit 109 through the direct electrical coupling as described above.

The video image selector 116 includes a number of directional buttons 173 including, for example, a “left front” button LF, a “right front” button RF, a “left rear” button LR, and a “right rear” button RR. The directional buttons 173 allow a user to select a respective left front, right front, left rear, or right rear video image 111 (FIG. 2) from a corresponding camera 103, 106 (FIG. 2) associated with such positions to be included as one of the output video images 133 on a respective monitor 113 associated with the video image selector 116. Also, the directional buttons 173 may be employed for other purposes such as controlling zoom and pan functions as they apply to a particular output video image 133 as will be described.

In addition, the video image selector 116 includes a multi-view button 176 that directs the video processing unit 109 to generate an output video image 133 that includes two, three, or four or more video images 111 from multiple ones of the cameras 103, 106 that are included in the subset 165 (FIG. 2). For example, in one embodiment the video images 111 from four cameras 103, 106 are displayed in a single output video image 133 applied to the monitor 113. Such a display is termed a “quad” view herein.

In addition, the video image selector 116 includes a day/night button 179 that is used to control whether the subset 165 of video images 111 are generated by visible light cameras 103 or night vision cameras 106. In one embodiment, each one of the output video images 133 generated by the video processing unit 109 is generated only by either visible light cameras 103 or night vision cameras 106.

Also, the video image selector 116 includes a “forward-reverse/side-to-side” button 183. The forward-reverse/side-to-side button 183 is employed to select the subset 165 of video images 111 generated by cameras 103, 106 that are facing in the longitudinal direction 126 (FIG. 1) (i.e. in a forward or reverse direction), or video images 111 generated by cameras 103, 106 that are facing in the lateral direction 129 (FIG. 1) (i.e. in a side direction) with respect to the vehicle 100. In addition, the forward-reverse/side-to-side button 183 may be used for other purposes as will be described.

In this respect, operators may advantageously choose between viewing areas in front and behind the vehicle 100, or on either side of the vehicle 100. When any one of the button 173, 176, 179, 183 are depressed, the video image selector 116 provides a signal to the controller ECU 169 which in turn generates a message on the data bus 166 that is transmitted to and received by the control processor 153 (FIG. 2) of the video processing unit 109. The control processor 153 then reacts accordingly. The messages generated on the data bus 166 by the controller ECU 169 include parameter identifiers that inform the control processor 153 the video processor 156a/156b for which the message is intended. In this respect, each of the video image selectors 116 is associated with a respective one of the monitors 113, and correspondingly, with a respective one of the video processors 156a/156b.

Alternatively, the video image selector 116 may be directly coupled to the video processing unit 109 and the video processing unit 109 may react to the signals received directly from the video image selector 116 that are generated upon manipulating any one of the buttons 173, 176, 179, 183.

Turning to FIG. 4, shown is a schematic block diagram that provides an example of the control processor 153 according to an embodiment of the present invention. In this respect, the control processor 153 is a processor circuit that includes a processor 193 and a memory 196, both of which are coupled to a local interface 199. The local interface 199 may be, for example, a data bus with an accompanying control/address bus as can be appreciated by those with ordinary skill in the art.

Stored in the memory 196 and executable by the processor 193 are an operating system 203 and a control system 206. The control system 206 is executed by the processor 193 in order to orchestrate the operation of the video processing unit 109 in response to various inputs from the video image selectors 116 (FIG. 3) as will be described. In this respect, the control system 206 may facilitate communication with each of the encoders 163 (FIG. 2) and the video processors 156a/156b (FIG. 2).

The memory 196 is defined herein as both volatile and nonvolatile memory and data storage components. Volatile components are those that do not retain data values upon loss of power. Nonvolatile components are those that retain data upon a loss of power. Thus, the memory 196 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 193 may represent multiple processors and the memory 196 may represent multiple memories that operate in parallel. In such a case, the local interface 199 may be an appropriate network that facilitates communication between any two of the multiple processors, between any processor and any one of the memories, or between any two of the memories etc. The processor 193 may be of electrical, optical, or molecular construction, or of some other construction as can be appreciated by those with ordinary skill in the art.

The operating system 203 is executed to control the allocation and usage of hardware resources such as the memory, processing time and peripheral devices in the control processor 153. In this manner, the operating system 203 serves as the foundation on which applications such as the control system 206 depend as is generally known by those with ordinary skill in the art.

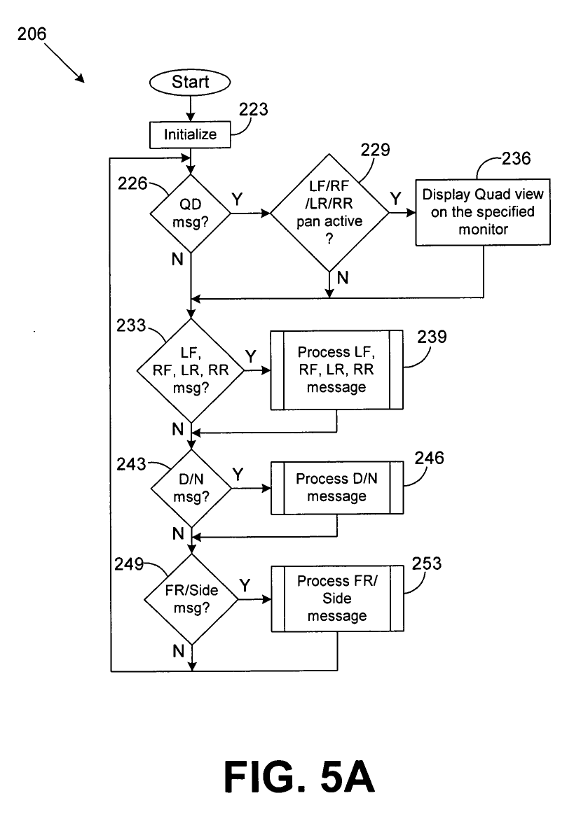

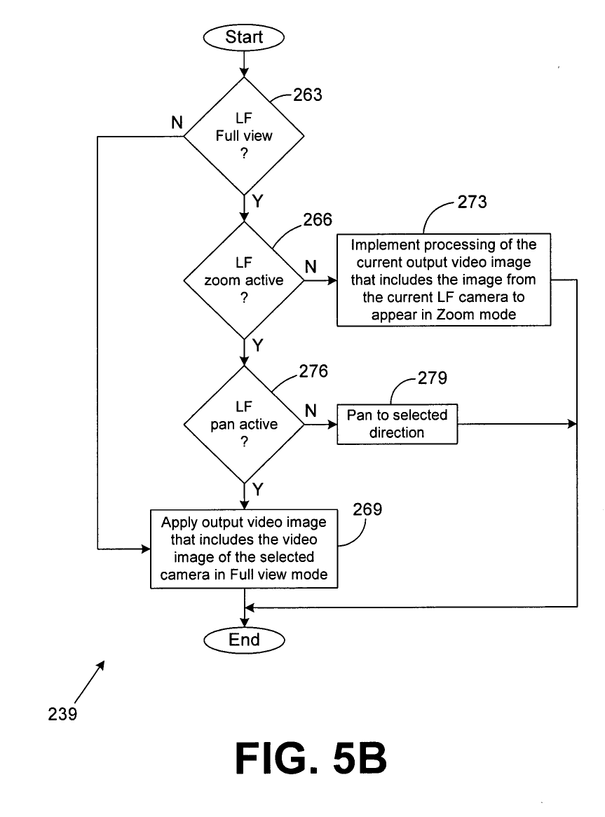

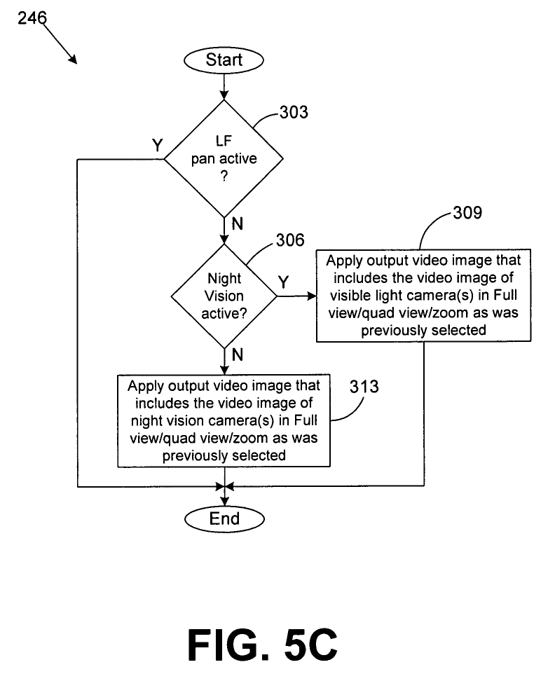

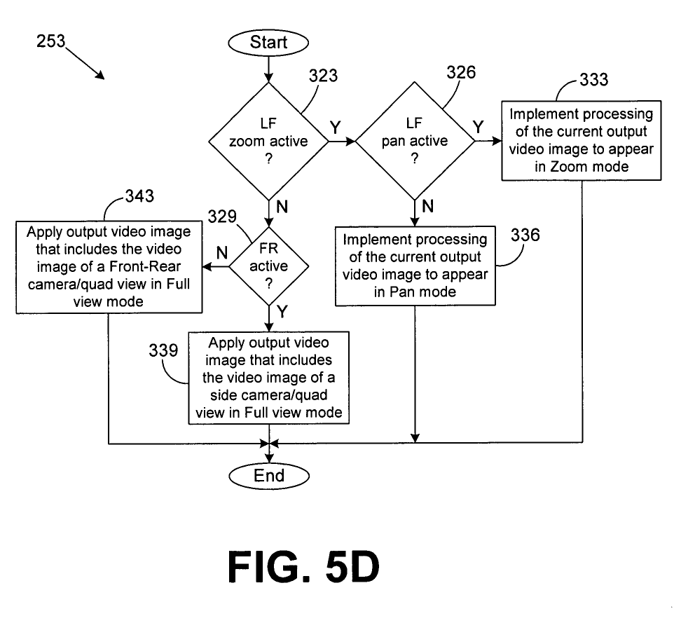

Turning to FIGS. 5A-5D, shown are flow charts that provide an example of the operation of the control system 206 according to an embodiment of the present invention. Alternatively, the flow charts of FIGS. 5A-5D may be viewed as depicting steps of an example of a method implemented in the control processor 153 (FIG. 2) to control the operation of the video processing unit 109 (FIG. 2). The functionality of the control system 206 as depicted by the example flow chart of FIGS. 5A-5D may be implemented, for example, in an object oriented design or in some other programming architecture. Assuming the functionality is implemented in an object oriented design, then each block represents functionality that may be implemented in one or more methods that are encapsulated in one or more objects. The control processor 153 may be implemented using any one of a number of programming languages such as, for example, C, C++, or other programming languages.

Beginning with box 223, the control system 206 initializes all registers and other aspects of the operation of the video processing unit 109. Thereafter, in box 226, the control system 206 determines whether a quad or other multiple video image command message has been received from a respective video image selector 116 (FIG. 3). In this respect, the quad message dictates that an output video image 133 (FIG. 2) is to be generated, for example, from all four of the video images 111 (FIG. 2) that make up the subset 165 (FIG. 2) from four respective cameras 103 or 106 (FIG. 2). The quad message is generated by depressing or otherwise manipulating the multiple image button 176 (FIG. 3).

Assuming that a quad message has been received from a respective one of the video image selectors 116 in box 226, then the control system 206 proceeds to box 229 in which it is determined whether a pan function is active with respect to a current output video image displayed on the respective monitor 113. While in a pan mode, the output video image 133 (FIG. 2) includes a single one of the video images 111 generated by a selected one of the cameras 103, 106 in the subset 165. In this respect, the pan function is a processing function within each of the video processors 156a/156b.

Assuming that a pan feature within a respective one of the video processors 156a/156b is active, then the control system 206 proceeds to box 233. Otherwise, the control system 206 progresses to box 236 in which the “quad” view is displayed on the specified monitor 113 by the video processing unit 109. In this respect, the control system 206 communicates with a respective one of the video processors 156a, 156b and directs the video processor 156a, 156b to display an output video image 133 that incorporates the video images 111 from multiple ones of the cameras 103, 106 included in the subset 165. Thereafter, the control system 206 progresses to box 233 as shown.

In box 233, the control system determines whether a directional button 173 (FIG. 3) such as, the left front button, right front button, left rear button, right rear button has been manipulated based upon a message received from the respective video image selector 116. If so, then the control system 206 proceeds to execute the process 239 that controls the full view, pan, and zoom functions as will be described. Otherwise the control system 206 progresses to box 243.

In box 243, the control system 206 determines whether a day/night message has been received from a respective one of the video image selectors 106 to be directed to one of the video processors 156a, 156b to switch between the application of visible light cameras 103 or night vision cameras 106 to the respective video processor 156a, 156b identified in the day/night message. If such is the case, then the control system 206 proceeds to execute process 246 that controls the selection of the visible light cameras 103 or the night vision cameras 106 as the subset 165 of cameras 103, 106. Otherwise, the control system 206 progresses to box 249. In box 249, the control system 206 determines whether a forward-reverse/side-to-side message has been received from a respective one of the video image selectors 116. If such is the case, then the control system 206 executes the process 253. Otherwise, the control system 206 reverts back to box 226.

Referring next to FIG. 5B, shown is a flow chart of the process 239. While the process 239 is described with respect to a “left front” (LF) camera 103, 106, the same logic applies for all cameras 103, 106. Beginning with box 263, the process 239 determines whether the current output video image 133 incorporates one of the video images 111 generated by one of the cameras 103, 106 in a full view that is applied to the respective one of the monitors 113 (FIG. 1). If the full view of the respective video image 111 is already incorporated as the output video image 133, then the process 239 proceeds to box 266. Otherwise, the process 239 jumps to box 269.

In box 269, the process 239 directs the respective video processor 156a, 156b identified in the respective message to generate the output video image 133 incorporating the full view of the respective video image 111 of the selected camera 103, 106 based upon the directional button 173 pressed in the video image selector 116 as identified in the message received by the control processor 153. In this respect, the output video image 133 includes the video image 111 of the selected camera 103, 106 in a full view mode such that the entire monitor 113 displays the video image 111 from a respective one of the cameras 103, 106. Thereafter, the process 239 ends as shown.

Assuming that the process 239 has proceeded to box 266, then the full view of the video image 111 from the respective camera 103, 106 associated with the directional button 173 depressed on the video image selector 163 is already displayed in the respective monitor 113 associated with the respective video image selector 116. In such case, in box 266 the process 239 determines whether the zoom function with respect to the current full view displayed as a rendering of the output video image 133 is active.

The zoom function performs a digital zoom with respect to the output video image 133 currently displayed in the respective monitor 113. If the zoom function is inactive, then the process 239 proceeds to box 273 in which the zoom function is activated with respect to the current output video image 133 displayed on the respective monitor 113. Thereafter, the process 239 ends as shown. On the other hand, assuming that the zoom function is already active as determined in box 266, then in box 276 the process 239 determines whether a pan function with respect to the current output video image 133 is active. In this respect, the pan function allows a user to move around within the video image 111 from the respective one of the cameras 103, 106.

If the pan function is active in box 276, then in box 279 the process 239 causes the current output video image 133 to pan to a selected direction based upon the respective one of the directional buttons 173 (FIG. 3) depressed in the video image selector 116. In this respect, the directional buttons 173 serve multiple purposes such as, for example, selecting a full view from a respective one of the cameras 103, 106 to be displayed as the output video image 133, activating a zoom function with respect to a currently displayed full view of a video image 111 within the output video image 133, or panning the output video image 133 in a selected direction. In order to pan a view in various directions, according to one embodiment the directional buttons 173 control the pan function in that the left front LF and right front RF buttons 173 direct panning in the left and right directions, respectively. The left rear LR and right rear RR buttons 173 direct panning in the up and down directions, respectively. In addition, when in pan mode, the multi-view button 176 may be depressed to pan to the center of the output video image 133.

However, if in box 273 the pan function is inactive with respect to the current output video image 133, then the process 239 proceeds to box 269 in which the full view of the video image 111 from a respective camera 103, 106 is incorporated as the current output video image 133 to be displayed on the respective monitor 113. In this respect, depressing one of the directional buttons 173 may cause the display of a full view of one of the video images 111, the zooming of a current full view of a video image 111, or a pan movement with respect to a displayed video image 111 in a respective one of the output video images 133.

The flow chart of FIG. 5C generally describes the functions within the control system 206 that provide for switching between the use of visible light cameras 103 (FIG. 2) and night vision cameras 106 (FIG. 2) for generation of the output video images 133 (FIG. 2). Specifically, the flow chart of FIG. 5C describes how the control system 206 directs the various video encoders 163 to apply the video image 111 (FIG. 2) generated by either the visible light cameras 103 or the night vision cameras 106 to the multiplexed inputs of a respective one of the video processors 156a/156b (FIG. 2), depending upon the particular video image selector 116 manipulated accordingly.

Beginning with box 303, the process 246 determines whether a pan function is active with respect to a particular full view of a video image 111 incorporated within an output video image 133 applied to a respective one of the monitors 113 by the respective one of the video processors 156a/156b. If so, then the process 246 ends. In this respect, the control system 206 prevents the selection of the video images 111 from visible light or night vision cameras 103, 106 as one of the subsets 165 of video images 111 if a respective video processor 156a/156b currently implements a pan function with respect to the output video image 133 generated thereby.

Assuming that no pan function is active in box 303, then the process 246 proceeds to box 306 in which it is determined whether the video images 111 of the current subset 165 are generated by night vision cameras 106. If so, then the process 246 proceeds to box 309 in which the video images 111 from visible light cameras 103 are selected as the subset from which an output video image 133 is generated. The output video image 133 is generated in the same mode as was previously viewed during use of the night vision cameras 106. Thereafter, the process 246 ends as shown.

On the other hand, if the video images 111 generated by the night vision cameras 106 are not currently selected as the subset of video images 111 applied to the multiplexed inputs of a respective video processor 156a, 156b, then the process 246 proceeds to box 313 in which the video images 111 of the respective night vision cameras 106 are applied to the multiplexed inputs of a respective one of the video processors 156a, 156b and a corresponding output video image 133 is generated. Thereafter, the process 246 ends as shown.

In this respect, it is seen that the depressing of the day/night button 179 (FIG. 3) causes a toggling between the use of the visible light cameras 103 and the night vision cameras 106 to generate the output video image 133 displayed on a respective one of the monitors 113.

Turning then to FIG. 5D, next is a discussion of the process 253 that is executed in response to a receipt of the forward-reverse/side-to-side message generated by a manipulate of the forward-reverse/side-to-side button 183 (FIG. 3). It is understood that the discussion of the flow chart of FIG. 5D is performed with reference to a video image 111 from a left front (LF) camera 103, 106 that is incorporated within the output video image 133. In addition, the same applies with respect to the remaining ones of the cameras 103, 106.

Beginning with box 323, the process 253 determines whether the zoom function is active with respect to a full view of a video image 111 generated by a left front (LF)/left side front (LSF) camera 103, 106. If the zoom function is active, then the process 253 proceeds to box 326. Otherwise, the process 253 progresses to box 329 as shown. In box 326, the process 253 determines whether a pan function is active with respect to the current output video image 133 applied to the respective one of the monitors 113. If such is the case, then the process 253 progresses to box 333. Otherwise, the process 253 progresses to box 336 as shown.

In box 333, the zoom function is activated with respect to the current output video image 133 that includes the video image 111 generated by one of the left front LF or left side front LSF cameras 103, 106. Thereafter, the process 253 ends as shown. Assuming however, that the pan function is not active in box 326, then in box 336 the process 253 implements the pan function with respect to the current output video image 133 that incorporates the video image 111 generated by a respective left front LF or left side front LSF cameras 103, 106. Thereafter, the process 253 ends as shown.

Thus, the process 253 facilitates, for example, the activation and deactivation of the pan function with respect to a particular output video image 133 that incorporates the video image generated by a respective camera 103, 106 as described.

However, assuming that the zoom feature is not active in box 323 with respect to the current output video image 133, then the process 253 progresses to box 329 in which it is determined whether the video images 111 generated by the cameras 103, 106 that face a forward/reverse or longitudinal direction with respect to the vehicle 100 (FIG. 1) are currently selected as the subset 165 applied to the multiplexed inputs of a respective one of the video processors 156a, 156b, depending upon the respective video image selector 116 that includes the forward-reverse/side-to-side button 183 (FIG. 3) that was manipulated to trigger the execution of the process 253.

If the video images 111 generated by the cameras facing the longitudinal direction 126 are applied to the multiplexed inputs of the respective video processor 156a/156b as determined in box 329, then the process 253 proceeds to box 339. Otherwise, the process 253 progresses to box 343. Assuming that the process 253 has progressed to box 339, then the video images 111 generated by the cameras 103, 106 facing a lateral direction 129 are applied to the inputs of the respective video processor 156a/156b. Thereafter, the process 253 ends.

Assuming that the process 253 has progressed to box 343, then the process 253 manipulates the respective video encoders 163 so as to apply the video images 111 from the cameras 103, 106 facing the longitudinal direction 126 to the multiplexed inputs of the respective video processor 156a/156b. The corresponding output video image 133 thus incorporates the video images 111 from the cameras 103, 106 facing the longitudinal direction 126. In this respect, a full view of a single one of the cameras 103, 106 or a quad view that incorporates the video images 111 from multiple ones of the cameras 103, 106 oriented in a longitudinal direction 126 are applied to the monitor 113. Thereafter, the process 253 ends as shown.

In addition, while FIGS. 5A-5D discuss the control of the video processing unit 109 using the specified buttons on the video image selector 116, it is understood that the particular control configuration and logic discussed merely provides an example, and that other input components and logic may be used to the same end.

Although the control system 206 (FIGS. 5A-5D) is described as being embodied in software or code executed by general purpose hardware as discussed above, as an alternative the control system 206 may also be embodied in dedicated hardware or a combination of software/general purpose hardware and dedicated hardware. If embodied in dedicated hardware, the control system 206 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The block diagram/diagrams and/or flow chart/charts of FIGS. 5A-5D show the architecture, functionality, and operation of an implementation of the control system 206. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 5A-5D show a specific order of execution, it is understood that the order of execution may differ from that which is depicted. For example, the order of execution of two or more blocks may be scrambled relative to the order shown. Also, two or more blocks shown in succession in FIGS. 5A-5D may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the control system 206 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the control system 206 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

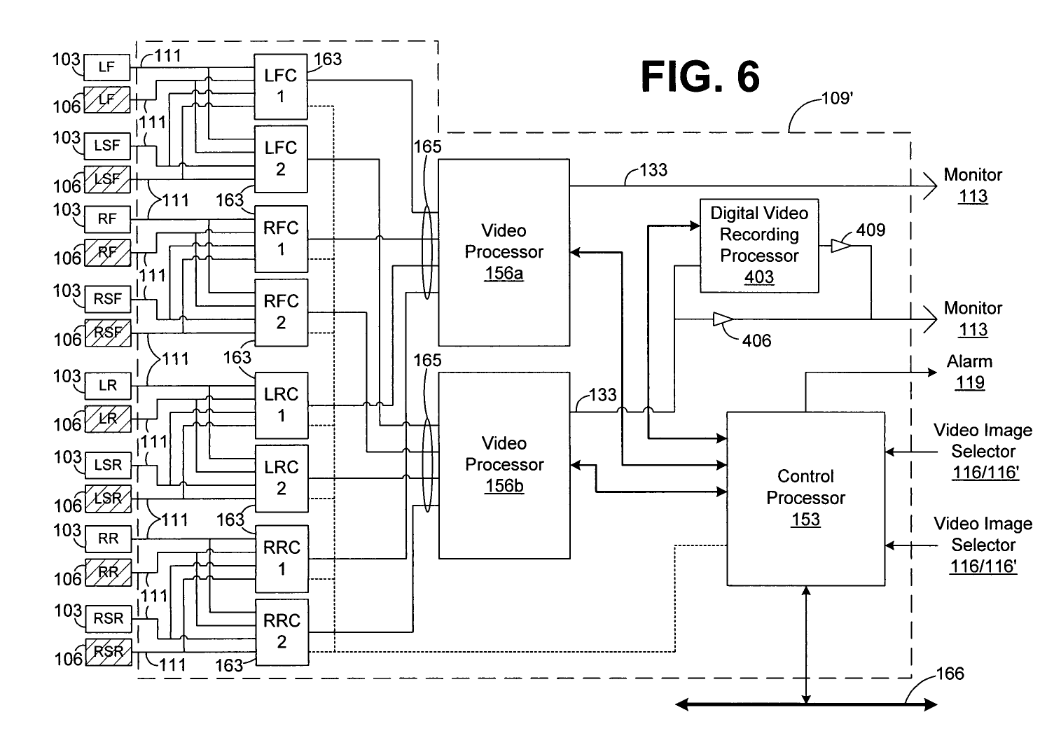

With respect to FIG. 6, shown is a schematic of a video processing unit 109′ according to another embodiment of the present invention. The video processing unit 109′ is similar to the video processing unit 109 (FIG. 2) with a few alterations as will be described. Those components of the video processing unit 109′ that are the same as components in the video processing unit 109 are denoted using the same reference numbers. In this respect, the video processing unit 109′ includes the control processor 153, the at least two video processors 156a and 156b, and a digital video recording processor 403. The control processor 153 is electrically coupled to each of the video processors 156a and 156b to facilitate data communications therebetween. The digital video recording processor 403 may be, for example, a PVR-1 Module manufactured by Volicon, Inc., a division of Exatel Broadcast Systems of Burlington, Mass., or other device with like capability.

The video processing unit 109′ is configured to select a number of subsets of the cameras 103, 106 from which output video images 133 may be generated in a manner similar to the video processing unit 109 described above. In this respect, the video processing unit 109′ generates at least two output video images 133 that are applied to corresponding ones of the monitors 113.

In addition, the video processing unit 109′ includes a digital video recording processor 403 that is employed to process one of the output video images 133. In this respect, one of the output video images 133 is applied to a video input of the digital video recording processor 403 as will be described.

In this respect, one of the output video images 133 is applied to a video input of the digital video recording processor 403. In addition, the video processing unit 109′ includes amplifiers 406 and 409. The amplifiers 406 and 409 provide a buffer between the various circuits of the video processing unit 109′ and the monitor 113. The outputs of the amplifiers 406 and 409 are tri-stated so that they may be enabled or disabled via a control signal generated by the control processor 153, where the control connection is not shown. The amplifiers 406 and 409 are enabled by control signals from the control processor 153 in order to selectively apply the output video image 133 to the monitor 113 either through the digital video recording processor 403 or bypassing the digital video recording processor 403. Specifically, the output video image 133 may be directly applied to the monitor 113 when the amplifier 406 is enabled and the amplifier 409 is disabled. On the other hand, when the amplifier 409 is enabled and the amplifier 406 is disabled, the output video image from the digital video recording processor 403 is applied directly to the monitor 113, thereby bypassing the digital video recording processor 403.

Next, the general operation of the video processing unit 109′ is provided. In this respect, the operation of the video processing unit 109′ is similar to the operation of the video processing unit 109 described above. In addition, appropriate inputs to the control processor 153 received from a video image selector 116′ directs the operation of the digital video recording processor 403 with respect to the digital video processing unit 109′. In this respect, the control processor 153 receives commands from a video image selector 116′ and communicates with the digital video recording processor 403 to implement a desired function requested by an operator. The control processor 153 also enables or disables the amplifiers 406 and 409 to determine whether the output video image 133 is applied directly to the monitor 113 from the video processor 156b or whether the output video image 133 is first applied to the digital video recording processor 403, the output of which is then applied to the monitor 113.

In this respect, the video processing unit 109′ may operate in one of two modes. These modes may include, for example, a digital video recording (DVR) mode and “video bypass” mode. In the digital video recording mode, the output video image 133 is applied to the digital video recording processor 403. Also, the output of the amplifier 409 is enabled to apply the output of the digital video recording processor 403 to the monitor 113. In this respect, in the DVR mode, the amplifier 406 is disabled by the control processor 153 to prevent the output video image 133 from being directly applied to the monitor 113. In this respect, a collision is prevented between the video output of the digital video recording processor 403 and the output video image 133 if such were directly applied to the monitor 113 through the amplifier 406.

In the video bypass mode, the amplifier 409 is disabled and the amplifier 406 is enabled. In this respect, the output video image 133 is thus applied directly to the monitor 113, effectively bypassing the digital video recording processor 403. This is advantageous because the processing performed on the output video image 133 by the digital video recording processor 403 results in a delay of the output video image 133 before it is applied to the monitor 113. Consequently, if an operator wishes to view the current real time video image on a monitor 113 without the delay, the digital video recording processor 403 is bypassed and the output video image 133 is directly applied to the monitor 113 through the amplifier 406. Thus, in the video bypass mode, the amplifier 409 is disabled. The video bypass mode thus may also be described as a “real time” mode in which the view depicted on a monitor 113 is real time video without an appreciable delay.

In addition, the digital video recording processor 403 provides for several capabilities with respect to the output video image 133 applied thereto. Specifically, the digital video recording processor 403 cyclically records a predefined time period of the output video image 133 at all times. For example, the digital video recording processor 403 may continuously record, for example, the last eight hours of the output video image 133 applied thereto. Alternatively, some other period of time may be stored, depending upon the video data storage capacity of the digital video recording processor 403. In this respect, the output video image 133 is stored in an appropriate memory device, such as, for example, a non-volatile random access memory, a hard drive or other memory device. The recording of the output video image 133 by the digital video recording processor 403 is “cyclical” in that once that the full time period is recorded, then the digital video recording processor 403 begins to record the newest frames of the output video image 133 over the oldest frames of the output video image 133 stored. Consequently, assuming that the time period were, for example, eight hours, then only the last eight hours of the most recent output video image 133 is stored to be reviewed as is appropriate.

In addition, the digital video recording processor 403 includes various features such as a pause feature, a hop feature, playback, fast forward, and rewind. For example, assuming that th ate video image selector to execute a hop in the video. Specifically, when in DVR mode, the user manipulates the video image selector to generate a hop signal that is transmitted to the control processor 153, the control processor 153 then sends a signal to the digital video recording processor 403 instructing the digital video recording processor 403 to execute a hop in the output video image 133 transmitted to the monitor 113.

In this respect, a “video hop” is defined herein as jumping back in time in the output video image 133 stored by the digital video recording processor 403 by a predefined period of time relative to the current position of the output video image and playing the output video image 133 beginning at the earlier position.

To implement the playback feature of the video processing unit 109′, a user manipulates a video image selector 116′ to transmit a control signal to the control processor 153 indicating that playback of the output video image 133 at its current position is desired. In response, the control processor 153 transmits a signal to the digital video recording processor 403 causing it to play back the output video image 133. In addition, the user may manipulate a video image selector 116′ to fast forward or rewind the output video image 133. Specifically, appropriate fast forward and rewind control signals are generated by a video image selector 116′ upon manipulation by an operator. Such signals are applied to the control processor 153 that in turn applies appropriate signals to the digital video recording processor 403 to cause the digital video recording processor 403 to fast forward or rewind the output video image 133 as desired.

Specifically, the digital video recording processor 403 provides for a number of fast forward speeds and rewind speeds. Each time the video image selector 116′ is manipulated to generate a control signal indicating a change in the fast forward or rewind speed, then the digital video recording processor 403 cycles through the fast forward or rewind speeds in the playback of the output video image 133. In this regard, a user may control the playback speed of the output video image 133 by the digital video recording processor 403.

In addition, the digital video recording processor 403 may generate time stamps that are stored relative to the output video image 133 for future reference. For example, whenever motion may be detected as described above, the control processor 153 may send a message to the digital video recording processor indicating that motion has been detected. In response the digital video recording processor 403 may be configured to record a digital time stamp in association with the particular video frame within which motion was detected. Such a time stamp may include, for example, the date, time, and the event associated with the time stamp, where the event may be, for example, detection of motion, information from the vehicle data bus 166, or other appropriate event. In this respect, time stamps may be stored in connection with events other than motion detection such as other detected events or predefined operator inputs, etc.

In addition, the digital video recording processor 403 may be configured to generate a text overlay that is placed on top of the output video image 133 processed by the digital video recording processor 403 for view on the monitor 113. In this respect, the control processor 153 may provide the substance that is depicted in the overlay such as, for example, images for text, etc. In this respect, the control processor 153 may generate components of such an overlay based upon inputs received from the data bus 166 as described above. Alternatively, images or text may be overlaid onto the output video image 133 that indicate the state of the operation of the digital video recording processor 403 such as indicating video bypass or digital video recording modes, playback, pausing, fast forward, rewind, and other operational information.

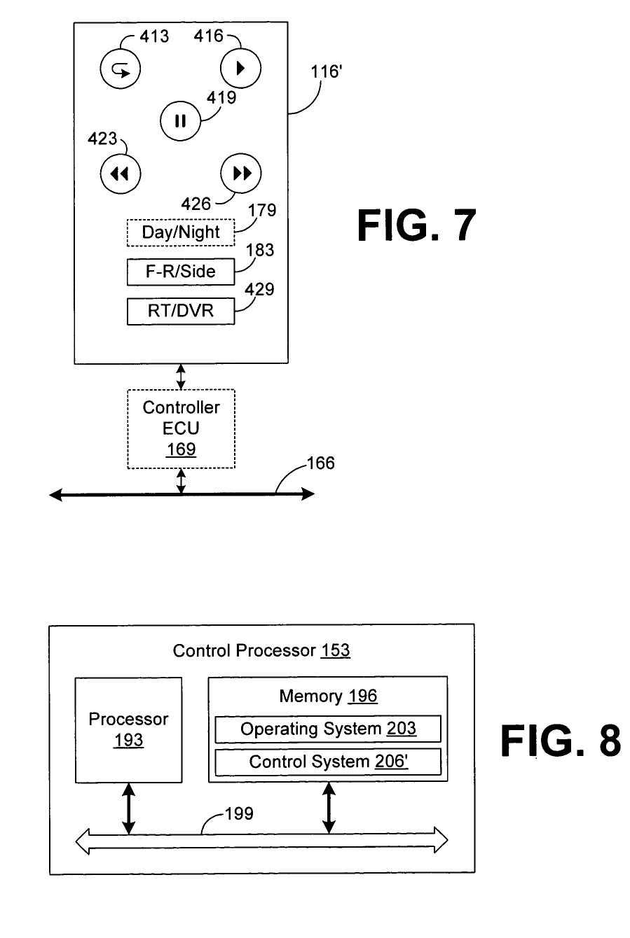

With reference to FIG. 7, shown is a video image selector 116′ according to an embodiment of the present invention. The video image selector 116′ is similar in most respects with the video image selector 116 (FIG. 3) and includes the fact that the several buttons or other input devices are employed for dual purposes. Specifically, the video image selector 116′ includes a “hop” button 413, a “playback” button 416, a “pause” button 419, a “reverse” button 423, a “fast forward” button 426, and a “Real Time(RT)/DVR mode” button 429. In addition, the day/night selection button 179 and the F-R/Side button 183 are provided as described above. The hop, playback, pause, reverse, and fast forward buttons may be, for example, buttons 173 and 176 as described with reference to the video image selector 116. In this respect, such buttons may perform dual purposes as described herein. Specifically, the purpose of each button depends upon whether the video processing unit 109′ is in video bypass (i.e. Real Time) mode or digital video recording mode. The RT/DVR mode button 429 serves to switch between the two modes.

The hop button 413 is manipulated by an operator to initiate a hop within the output video image 133 depicted on the monitor 113 as described above. In order to play the output video image 133, the operator may manipulate the playback button 416. Similarly, to pause, rewind, or fast forward the playback on the monitor 113, the user may manipulate the pause, rewind, or fast forward buttons 419, 423, and 426. To toggle between the video bypass and DVR modes, a user may manipulate the video bypass/DVR button 429. Each time one of the buttons 413, 416, 419, 423, 426, and 429 are manipulated by a user, the video image selector 116′ causes the controller ECU 169 to generate a corresponding control signal that is applied to the control processor 153 as appropriate control input. The control processor 153 then reacts and performs such functions as are necessary based upon the nature of the control input received.

Turning to FIG. 8, shown is a schematic block diagram that provides another example of the control processor 153 according to an embodiment of the present invention. In this respect, the control processor 153 includes the same components as described above with reference to FIG. 4 with the exception that the control system 206′ includes the additional functionality that allows the control processor 153 to receive the various control inputs from the video image selector 116′ and to communicate with the digital video recording processor 403 and the amplifiers 406 and 409 as described above.

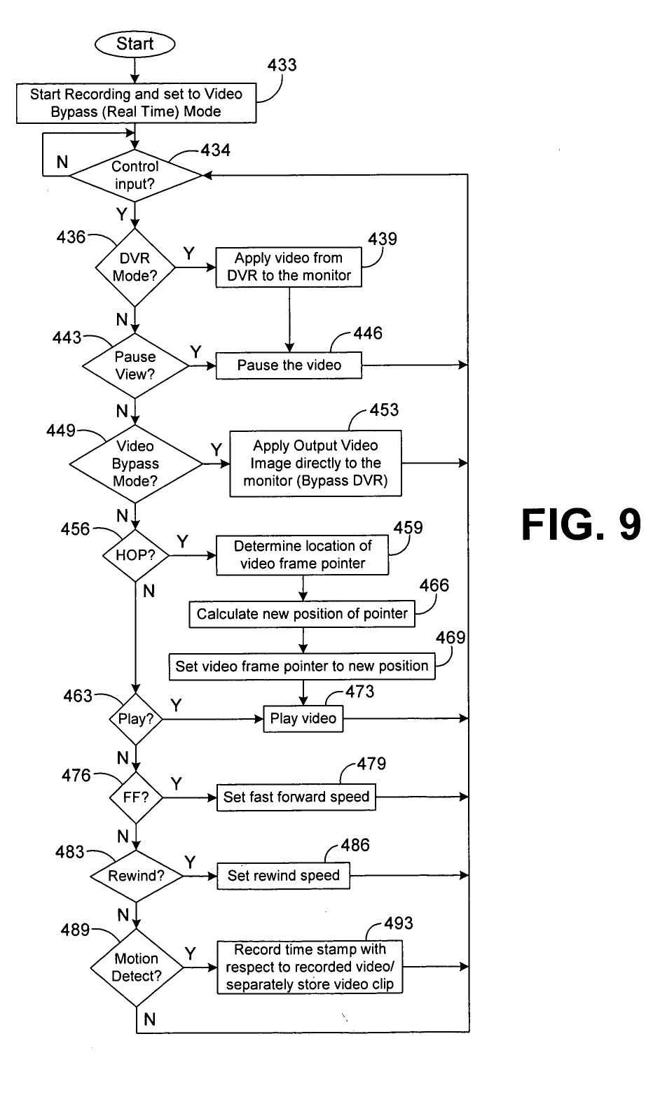

With reference to FIG. 9, shown is a flow chart that provides an example of the operation of a portion of the control system 206′ that controls the operation of the digital video recording processor 403 (FIG. 6) according to an embodiment of the present invention. Alternatively, the flow charts of FIG. 9 may be viewed as depicting steps of an example of a method implemented in the control processor 153 (FIG. 8) to control the operation of the video processing unit 109′ (FIG. 6) in implementing the various functions provided by the digital video recording processor 403. The functionality of the control system 206′ as depicted by the example flow chart of FIG. 9 may be implemented, for example, in an object oriented design or in some other programming architecture. Assuming the functionality is implemented in an object oriented design, then each block represents functionality that may be implemented in one or more methods that are encapsulated in one or more objects. The control system 206′ may be implemented using any one of a number of programming languages such as, for example, C, C++, Assembly, or other programming languages. In addition, other functionality may performed by the control processor 153 and the digital video recording processor 403 that is not described herein, where the flow chart of FIG. 9 illustrates various functionality according various embodiments of the present invention.

Beginning with box 433, the control system 206′ initiates recording of the output video image 133 (FIG. 6) and initiates operation in the video bypass mode as described above. This is performed generally when the video processing unit 109′ is first powered up or initialized, etc. Thereafter, in box 434 the control system 206′ waits to receive a control input generated by a user manipulation of the video image selector 116′ as described above. Assuming that a control input is so received, then the control system 206′ proceeds to box 436.

In box 436, the control system 206′ determines whether a command has been received from a video image selector 116′ (FIG. 7) that indicates that the operator wishes to switch the operating mode to digital video recording mode based upon a manipulation of the RT/DVR mode button 419 (FIG. 7). If so, then the control system 206′ proceeds to box 439. Otherwise, the control system 206′ moves to box 443. In box 439, the control system 206′ applies the output video image 133 from the digital video recording processor 403 to the monitor 113 (FIG. 6). Specifically, the amplifier 409 is enabled and the amplifier 406 is disabled by the control processor 153. Thereafter, the control system 206′ proceeds to box 446.

In box 443 it is determined whether the output of the digital video recording processor 403 (FIG. 6) is to be paused based upon a control input received from the video image selector 116′ generated due to a manipulation of the pause button 419 (FIG. 7). If so then the control system 206′ proceeds to box 446. Otherwise, the control system 206′ proceeds to box 449. In box 446, the output video image 133 of the digital video recording processor 403 that is applied to the monitor 113 (FIG. 1) is paused. Thereafter, the control system 206′ reverts back to box 434 to wait to process another command from the video image selector 116′.

In box 449, the control system 206′ determines whether video bypass mode has been selected based upon the appropriate control input received by the control processor 153 from the video image selector 116′ due to a manipulation of the RT/DVR mode button 429. If video bypass mode is determined to have been selected in box 449, then the control system 206′ proceeds to box 453. Otherwise the control system 206′ progresses to box 456. In box 453 the output video image 133 from the video processor 156b is applied directly to the monitor 113, thereby bypassing the digital video recording processor 403. In this respect, the amplifier 406 is enabled and the amplifier 409 is disabled. Assuming that the video processing unit 109′ is already in video bypass mode, then the actions of the control system 206′ in this respect have no effect. Thereafter, control system 206′ reverts back to box 434 to wait to process another command from the video image selector 116′.

In box 456, the control system 206′ determines whether a video hop is to be implemented based upon an appropriate control input received at the control processor 153 from the video image selector 116′ generated due to a manipulation of the video hop button 413 (FIG. 7). Assuming that a video hop is deemed to be implemented, then the control system 206′ proceeds to box 459. Otherwise, the control system 206′ progresses to box 463.

Assuming that a video hop is to be implemented, then in box 459 the control system 206′ determines the current location of a video frame pointer within the digital video recording processor 403. The video frame point indicates the particular video frame that is to be displayed on the monitor at any given time. The current location of the video frame pointer may be determined, for example, by transmitting a request from the control processor 153 to the digital video recording processor 403 that requests the value of the video frame pointer. Thereafter, in box 466, a new position of the pointer is calculated that corresponds to the particular hop in the output video image 133 that is desired. Specifically, a new value to be employed for the video frame pointer is calculated such that the total number of frames to be jumped corresponds to the number of seconds or other time interval associated with the predefined video hop. This may be done, for example, by knowing how many frames per second are stored in memory or on a data storage device in calculating the number of frames back necessary to accomplish a hop of the desired time interval.

Next, in box 469, the control system 206′ sets the video frame pointer to the new value calculated in box 466. This ultimately results in the digital video recording processor 403 displaying the current frame at the new frame pointer position and playback begins at such point. Thereafter, in the control system 206′ proceeds to box 473 in which the digital video recording processor 403 is placed in a “play” mode to play back the output video image 133 starting at the position indicated by the frame pointer. Thereafter, the control system 206′ reverts back to box 434 to wait to process another command from the video image selector 116′.

Assuming that the control system 206′ has proceeds to box 463, then it is determined whether a control input has been received by the control processor 153 that was generated by the video image selector 116′ by virtue of a user manipulating the “play” button 416 (FIG. 7) as described above. Assuming such is the case, then the control system 206′ proceeds to box 473 in which the digital video recording processor 403 commences playing the output video image 133 starting at the current position of the frame pointer. Thereafter, the control system 206′ reverts back to box 434 to wait to process another command from the video image selector 116′.

However, assuming that no control input informing the control processor 153 to place the digital video recording processor 403 in a play mode is received in box 463, then the control system 206′ proceeds to box 476. In box 476, the control system 206′ determines whether a control input has been received indicating that a fast forward speed is to be selected, where such control input was generated by the video image selector 116′. Assuming such is the case then the control system 206′ proceeds to box 479. Otherwise, the control system 206′ progresses to box 483.

In box 479, the fast forward speed is set by which the digital video recording processor 403 plays back the output video image 133. In this respect, the control processor 153 sets a fast forward speed of the playback by the digital video recording processor 403. In this respect, there may be a plurality of different fast forward speeds. Each time the fast forward button 426 (FIG. 7) is depressed, thereby generating a corresponding control input to the control processor 153, the control processor 153 transmits a message to the digital video recording processor 403 to increment the fast forward speed to a next possible speed. In this respect, the fast forward speeds may be, for example, 2×, 4×, 8× or other speed. Once the highest speed is reached, then the next time a control input is received via the control processor 153 indicating a desire to change the fast forward speed, then the control processor 153 responds by transmitting a message to the digital video recording processor 403 to revert back to the lowest fast forward playback speed (2×) for the output video image 133. In this respect, the setting of the fast forward speed is cyclical. After the fast forward speed is set in box 473, the control system 206′ reverts back to box 434 to wait to process another command from the video image selector 116′.

Assuming that the control system 206′ reaches box 483, then the control system 206′ determines whether the output video image 133 is to be played back in rewind mode at a particular rewind speed. If so, then the control system 206′ proceeds to box 486. Otherwise, the control system 206′ proceeds to box 489. Assuming that rewind of the output video image 133 is to implemented based on a control input received in the processor 153 that was generated by the video image selector 116′ as detected in box 483, then in box 486 the rewind speed of the digital video recording processor 403 is set. In this respect, the rewind speed may be any one of a plurality of rewind speeds such as, for example, 2×, 4×, 8×, or any other speed. In this respect, the rewind speed is set in a cyclical manner similar to the fast forward speed described above with respect to box 479. Specifically, once the maximum rewind speed is reached, depressing the rewind button 423 ultimately results in the rewind speed being set at 2× times in a similar manner to the fast forward speeds described above. After the rewind speed is set in box 486, the control system 206′ reverts back to box 434 to wait to process another command from the video image selector 116′.

Assuming that the control system 206′ has moved to box 489, then it is determined whether motion has been detected in the output video image 133 by a the video processor 156rocess another command from the video image selector 116′.

Assuming that motion is detected in box 489, then in box 493 a time stamp is recorded with respect to the output video image 133 stored in the appropriate memory of the digital video recording processor 403. In this respect, the control processor 153 sends a control message to the digital video recording processor 403 directing it to record a particular time stamp with respect to the output video image 133. A clock may be maintained in the digital video recording processor 403, the control processor 153, or by employing appropriate timekeeping circuitry coupled to the digital video recording processor 403 or the control processor 153, etc.

Alternatively, a video clip may be stored that encompasses a time period that includes the portions of the output video image 133 where the motion detection occurred. Such a clip may be either stamped within the output video image 133 stored during normal operation of the digital video recording processor 403, or a copy of the clip may be separately stored in an additional memory space so that it is not written over in the future given the cyclical operation of the digital video recording processor 403 in recording the predefined period of time of video as described above. Thereafter, the control system 206′ reverts back to box 434 to wait to process another command from the video image selector 116′.

Thus it is seen, that the control system 206′ places the digital video recording processor 403 in a beginning state and then waits for various inputs to be received based upon the user manipulation of the video image selector 116′ before action is taken as described above.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A vehicle video system, comprising:
a plurality of cameras mounted in a vehicle, each of the cameras generating a video image, the cameras including a plurality of visible light cameras and a plurality of night vision cameras;
a plurality of monitors;
a video processing unit, each of the cameras and each of the monitors being electrically coupled to the video processing unit, the video processing unit being configured to select at least two subsets of the cameras;
the video processing unit generating an output video image that incorporates at least one of the video images generated by at least one of the cameras in a first one of the subsets; and
a digital video recording processor included in the video processing unit that cyclically records a predefined time period of the output video image.

2. The vehicle video system of claim 1, wherein the video processing unit further comprises:
a digital video recording mode in which the output video image is applied to the digital video recording processor, and a video output of the digital video recording processor is applied to at least one of the monitors, the digital video recording processor recording the output video image; and
a video bypass mode in which the output video image is applied directly to the at least one of the monitors, wherein the output video image bypasses the digital video recording processor.

3. The vehicle video system of claim 2, further comprising a video image selector electrically coupled to the video processing unit, the video image selector being configured to provide a control input to the video processing unit, the control input selecting between the digital video recording mode and the video bypass mode.

4. The vehicle video system of claim 1, further comprising a video image selector electrically coupled to the video processing unit, the video image selector being configured to generate a plurality of control inputs to manipulate the operation of the video processing unit and the digital video recording processor.

5. The vehicle video system of claim 4, wherein the digital video recording processor is further configured to implement a video hop in the output video image to replay a portion of the output video image associated with a predefined period of time relative to a current position in the output video image, wherein the video hop is implemented in response to a predefined one of the control inputs generated by the video image selector.

6. The vehicle video system of claim 4, wherein the digital video recording processor is further configured to pause the output video image, wherein the pause of the output video image is implemented in response to a predefined one of the control inputs generated by the video image selector.

7. The vehicle video system of claim 4, wherein the digital video recording processor is further configured to implement a number of forward playing speeds to view the output video image on at least one of the monitors, wherein the forward playing speeds are selected in response to a predefined one of the control inputs generated by the video image selector.

8. The vehicle video system of claim 4, wherein the digital video recording processor is further configured to implement a number of reverse playing speeds to view the output video image on at least one of the monitors, wherein the reverse playing speeds are selected in response to a predefined one of the control inputs generated by the video image selector.

9. The vehicle video system of claim 1, wherein the video processing unit is further configured to record a time stamp in the output video image stored on a medium, the time stamp being generated by a detection of motion in the output video image.

10. A method for video control and display in a vehicle, wherein a plurality of cameras and a plurality of monitors are mounted in the vehicle, the cameras including a plurality of visible light cameras and a plurality of night vision cameras, each one of the cameras generating a video image, the method comprising the steps of:
selecting at least two subsets of the cameras;
generating an output video image that incorporates at least one of the video images generated by at least one of the cameras in a first one of the subsets; and
cyclically recording a predefined time period of the output video image.

11. The method of claim 10, wherein each of the cameras and each of the monitors is coupled to a video processing unit that includes a digital video recording processor that records the output video image, the method further comprising the steps of:
alternatively operating the video processing unit in one of a digital video recording mode and a video bypass mode, wherein the output video image is applied to the digital video recording processor, and a video output of the digital video recording processor is applied to at least one of the monitors when in the digital video recording mode; and
the output video image is applied directly to the at least one of the monitors, thereby bypassing the digital video recording processor when in the video bypass mode.

12. The method of claim 11, further comprising the step of manipulating a video image selector electrically coupled to the video processing unit to generate a control input that is applied to the video processing unit, the control input selecting between the digital video recording mode and the video bypass mode.

13. The method of claim 10, wherein each of the cameras and each of the monitors is coupled to a video processing unit that includes a digital video recording processor that records the output video image, the method further comprising the step of manipulating a video image selector electrically coupled to the video processing unit to generate a plurality of control inputs that are applied to the video processing unit, the control inputs manipulating an operation of the video processing unit and the digital video recording processor.

14. The method of claim 13, further comprising the step of manipulating the video image selector to generate one of the control inputs that directs the digital video recording processor to implement a video hop in the output video image to replay a portion of the output video image associated with a predefined period of time relative to a current position in the output video image.

15. The method of claim 13, further comprising the step of manipulating the video image selector to generate one of the control inputs that directs the digital video recording processor to pause the output video image.

16. The method of claim 13, further comprising the step of manipulating the video image selector to generate one of the control inputs that directs the digital video recording processor to implement a playback of the output video image at one of a plurality of forward playing speeds on at least one of the monitors.

17. The method of claim 13, further comprising the step of manipulating the video image selector to generate one of the control inputs that directs the digital video recording processor to implement a playback of the output video image at one of a plurality of reverse playing speeds on at least one of the monitors.

18. The method of claim 10, further comprising the step of recording a time stamp in the output video image stored on a medium, the time stamp being generated by a detection of motion in the output video image.

19. A vehicle video system, comprising:
a plurality of cameras mounted in a vehicle, each of the cameras generating a video image, the cameras including a plurality of visible light cameras and a plurality of night vision cameras;
a plurality of monitors;
a video processing means for selecting at least two subsets of the cameras and for generating an output video image that incorporates at least one of the video images generated by at least one of the cameras in a first one of the subsets, wherein each of the cameras and each of the monitors is electrically coupled to the video processing means; and
means for cyclically recording a predefined time period of the output video image.
